(19) United States
(12) Patent Application Publication
(10) Pub. No.: US 2008/0219395 A1
(43) Pub. Date: Sep. 11, 2008

(54) Nuclear power plant using nanoparticles in emergency situations and related method

(75) Inventors: Mihai G.M. Pop, Lynchburg, VA (US); Brian Glenn Lockamon, Evington, VA (US); Angelo Beati, Lyon (FR)

Correspondence Address: Davidson, Davidson & Kappel, LLC, 485 7th Avenue, 14th Floor, New York, NY, 10018, US

(73) Assignee: AREVA NP, Paris la Defense (FR)

(21) Appl. No.: 11/714,422

(22) Filed: Mar. 6, 2007

(51) Int. Cl. G21C 9/00

(52) U.S. Cl. 376/282; 376/293

(57) ABSTRACT

A nuclear power plant provides for delivery of nanoparticles to coolant found in the containment, for example during severe accident scenarios. The nanoparticles advantageously can be delivered passively or actively independently of any emergency core cooling system. The nanoparticle supply can include for example tanks storing nanofluids or solid nanoparticles, or dissolvable paints containing nanoparticles. Methods for providing the nanoparticles are also provided.

### BACKGROUND

The present invention relates general to nuclear power plants, and more specifically to the emergency systems of such power plants.

A nuclear power plant typically has a nuclear reactor and a reactor coolant system (RCS) for removing heat from the reactor and to generate power. The two most common types of reactors, boiling water reactors (BWRS) and pressurized water reactors (PWRs) are water-based.

In a pressurized water reactor (PWR), pressurized, heated water from the reactor coolant system transfers heat to an electricity generator, which includes a secondary coolant stream boiling a coolant to power a turbine. In BWRs, the reactor boils the reactor coolant directly to produce steam for the electricity generator. The RCS section downstream of the electricity generators but upstream of the reactor typically is called the cold leg, and downstream of the reactor and upstream of the electricity generators is typically called the hot leg.

If a failure occurs in the RCS, in what is typically called a loss of coolant accident (LOCA), the nuclear core does not properly cool, temperature begins to rise in the reactor. The temperature of the fuel elements in the core rises and, if not checked, can cause melt and potentially void the reactor, releasing the melt into the containment building. One type of LOCA accident which can occur in both PWRs and BWRs is a main steam line break (MSLB).

During such severe accidents for both PWRs and BWRs, a large quantity of cooling water can accumulate on the floor of the containment building, eventually reaching the outside of the reactor vessel and contributing substantially to its cooling. In such cases, the evolution of pressure and temperature inside the containment involves an increase in pressure to a few bars in 5-18 hours, with a maximum temperature around 150° C., which is reduced to atmospheric pressure and temperature in a few days. Nuclear power plants are designed to weather such an event with a considerable safety margin. The cooling process is based on the physical properties of water and air at those temperatures.

During a LOCA accident, an emergency core cooling system (ECCS) in both BWRs and PWRs can be activated to cool the reactor by providing additional water to the RCS. An ECCS typically thus includes a high-pressure pump such as a centrifugal charging pump/high pressure injection pump (CCP/HPIP pump) exiting into the RCS. This can pump water from the refueling water storage tank (RWST), such as an in-containment RWST, or a containment sump into the cold leg of the RCS. A volume control tank receiving water passing through a heat exchanger from the RCS cold leg can also provide water to the CCP/HPIP pump.

The ECCS also typically has a low-pressure pump, such as a residual heat removal or safety injection system pump (RHR/SIS pump), which can provide water from the RWST or containment sump to the cold and hot legs of the RCS, as well as water to a containment spray system. A heat exchanger is typically provided after the RHR/SIS pump.

Thus large volumes of water in the containment receiving heat from the reactor vessel walls can be cooled, depending on the type of plant through a combination of natural convection transmitting heat through the walls of the containment building to the environment and forced convection in the heat exchangers, which are part of the low pressure system having at one end the containment sump (inlet) and at the other end the containment spray system.

Post-accident cooling has to do with both phenomena of natural convection heat transfer of air and the vapor phase inside the containment following a LOCA accident as well as with the boiling heat transfer inside the core during the LOCA condition.

The article entitled “In-Vessel Retention Enhancement through the Use of Nanofluids” describes using nanofluids for In-Vessel retention enhancement during an accident scenario. The conceptual nanofluid injection system includes two small tanks of concentrated nanofluid, with each tank capable of supplying enough nanofluid to provide enhancement predicted by a computational model. The injection is considered to occur upon the manual actuation of valves connected to injections lines. Instructions to actuate these valves are required to be placed in the severe accident procedures. The injection is said to be driven by gravity and overpressure provided by accumulators attached to the tanks. The injection lines are such that they can terminate in the reactor cavity, in the recirculation lines, or in the IRWST, depending on the physical space limitations within containment.

### SUMMARY OF THE INVENTION

One object of the present invention is to improve the heat evacuation from the containment building under accident conditions, for example late stages of a severe accident.

The present invention provides a nuclear power plant comprising a reactor, a containment, the reactor being located in the containment, an emergency core cooling system for the reactor, and a nanoparticle supply independent of the emergency core cooling system and capable of delivering nanoparticles to the coolant located in the containment, for example in the late stages of a severe accident.

The present invention also provides a nuclear power plant comprising a reactor, a containment, the reactor being located in the containment, and a nanoparticle supply located in the containment and capable of providing nanoparticles directly to fluid in the containment.

The present invention also provides a nuclear power plant comprising a reactor, a containment, the reactor being located in the containment, and a self-contained nanoparticle supply located in or on the reactor, for example in the space between the exterior wall of the reactor vessel and the insulation or on the exterior wall of the reactor vessel.

The present invention also provides a nuclear power plant comprising a reactor, a containment, the reactor being located in the containment, and a nanoparticle supply located in the containment and actuatable as a function of a reactor coolant level, for example the reactor coolant level in the containment during the late phases of a severe accident.

The present invention also provides a nuclear power plant comprising a reactor, a containment, the reactor being located in the containment, and a nanoparticle-containing paint at various locations in the containment for example on the outside walls of the reactor vessel, the nanoparticle-containing paint dissolvable by the coolant.

The present invention also provides a method for improving accident heat removal capacity in a nuclear power plant comprising:

providing nanoparticles capable of being released directly into containment coolant found during an accident in a containment.

The present invention also provides a method for improving accident heat removal capacity in a nuclear power plant comprising:

providing nanoparticles capable of being released independently of an emergency core cooling system.

The present invention also provides a method for improving accident heat removal capacity in a nuclear power plant comprising:

painting sections of a containment, for example the outside wall of the reactor vessel, with a coolant-dissolvable nanoparticle-containing paint.

### BRIEF DESCRIPTION OF THE DRAWINGS

One preferred embodiment of the present invention will be described with respect to the drawing in which:

FIG. 1 shows schematically a nuclear power plant according to the present invention; and

FIG. 2 shows the details of the reactor area of the nuclear power plant of interest to the present invention in more detail.

### DETAILED DESCRIPTION OF THE PREFERRED EMBODIMENT

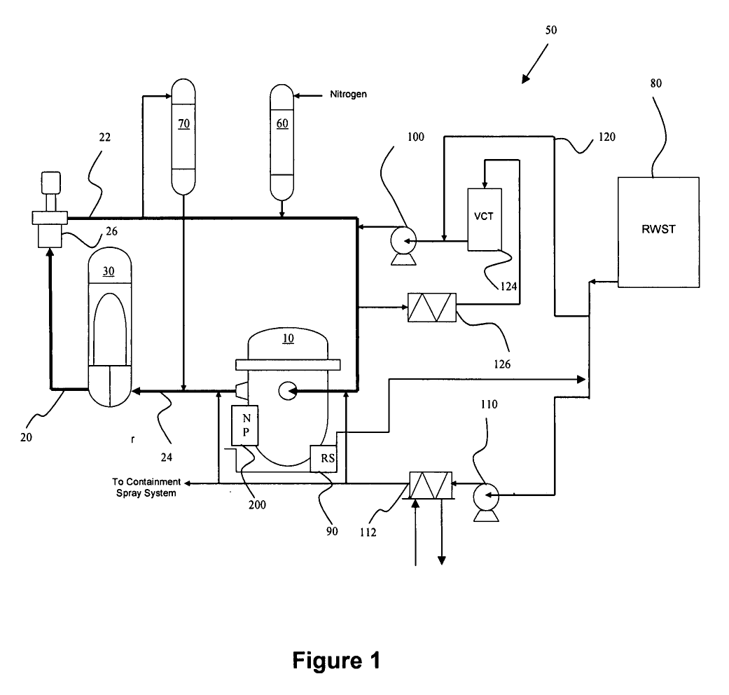

FIG. 1 describes the present invention with respect to a PWR nuclear power plant having a reactor 10, a reactor coolant system 20, and an electricity generator 30 including a secondary coolant stream and a turbine, for example. The reactor coolant system 20 includes a cold leg 22 between generator 30 and reactor 10, and a hot leg 24 between reactor 10 and generator 30, as well as a coolant pump 26 in cold leg 22. The reactor coolant system 20 also contains one or more pressurizers 70. Reactor 10 is located in a containment 190, which may be for example a sealed area of a building.

The present application is just as applicable to BWRs however, where electricity generator 30 may include a turbine without the secondary coolant stream, and where pressurizers 70 are not present.

RCS 20 recirculates water during normal operation, and in the preferred embodiment no nanoparticles are added intentionally to the RCS during normal operation, as these can cause issues with the generator and other components.

The nuclear power plant further includes an emergency core cooling system, indicated generally as 50, which includes one or more accumulators or core flooding tanks 60, a refueling water storage tank 80, a containment sump 90, a high pressure pump 100, and a low pressure pump 110.

RWST 80 is connected to the pump 100, which may be a centrifugal charging pump/high pressure injection pump, via a line 120. Pump 100 may also be connected to a volume control tank 124, which can receive water from cold leg 22 via a letdown heat exchanger 126. Pump 100 can provide water from RWST 80 or the containment sump 90 into the RCS 20 during a LOCA accident. Containment sump 90 thus provides water which collects in the containment during a severe accident, for example after RWST 80 has emptied.

Low pressure pump 110, which may be a residual heat removal/safety injection system pump, provides water from RWST 80 or containment sump 90 to a heat exchanger 112, and also to the hot leg 24, cold leg 22 and a containment spray system.

The present embodiment provides for a nanoparticle supply 200 which can provide concentrated nanofluid or nanoparticles directly to the containment fluid which collects following a severe accident, and independently of ECCS 50 and any other emergency cooling systems. Independent of the performance of those systems, the core cooling capacity in the later phases can be increased using nanoparticles according to the present invention. Nanoparticle supply 200 thus can provide significant advantages over nanoparticle supplies integrated as part of the safety systems operating under pressure.

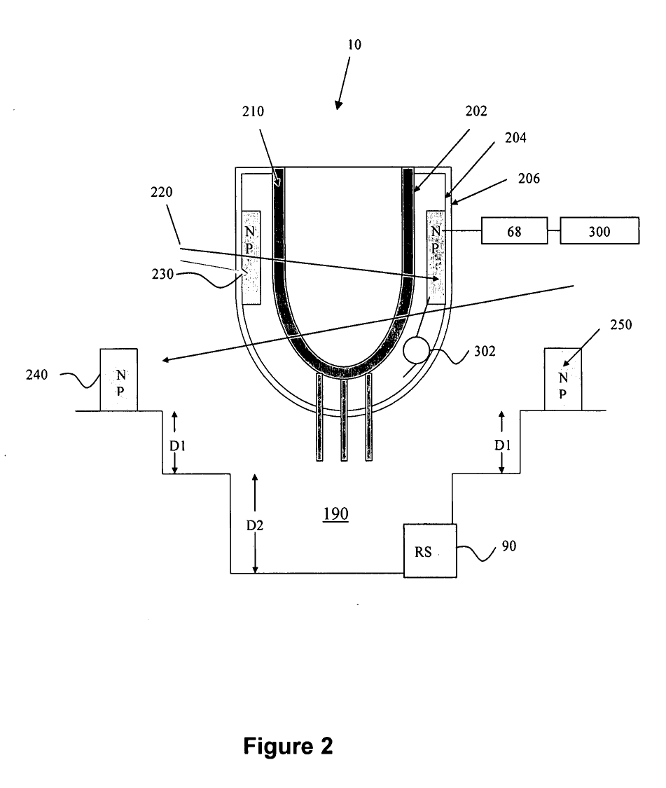

FIG. 2 shows reactor 10 and containment 190 in more detail. Nanoparticle supply 200 may include nanoparticle supplies 220 and 230 located between a mirror insulation outer shell 206 of reactor 10 and a reactor vessel 210, for example on an inside surface 204 of the insulation outer shell 206. Nanoparticle supply 200 can also include nanoparticle supplies 240 and 250 located in the containment 190, for example at a height D1+D2 over the bottom of the containment, D1 being for example two meters and D2 one meter. One or both of supplies 240, 250 however could also be located at height D2 for example, or even at the bottom level.

In addition, nanoparticle supply 200 can include a nanomaterial paint 202 on the outside of the vessel or other locations on the reactor 10 or the containment 190, for example on pipes 218. The paint 202 is liquid-soluble as will be described.

The nanoparticle supplies 220, 230, 240, 250 may include a plurality of nanomaterial tanks with total volume and maneuverability obtained considering probabilistic calculations of various operation strategies. The tanks can be a combination of dry nanopowder silos injecting nanopowder to the outlet or concentrated nanofluid tanks injecting the liquids into the outlet. The concentrated nanofluid tanks can have a system of feed and bleed that allow addition of nanofluids or nanomaterials to the tanks at given intervals to maintain the quality of the nanofluid suspension. A sensor 68 can sense the nanoparticle level, and a controller 300 can actuate drain valves and fill valves of each supply 220, 230, 240, 250 to provide a desired concentration. A motor-driven release valve 302 can be provided to permit release of the nanoparticles. Alternate to sensor 68, an operator can enter in a determined nanoparticle concentration in the tanks and desired concentration and the controller 300 can correct the concentration based on the known amounts of the tank volume. In addition, the entire quality of the nanofluid in the tanks may be maintained manually. If desired, controller 300 can be used to control the valves and nanoparticle delivery for supplies 220, 230, 240, 250 throughout the course of a severe accident event, for example from a control room.

The tanks of nanoparticle supplies 220, 230, 240, 250 can be pressurized using an inert gas such as nitrogen with a separation device such as a diaphragm, and actuated by a passive or active actuator. A passive actuator operates automatically without operator intervention. Thus, the paint 202 is passive, as is any nanoparticle supply 220, 230, 240, 250 which has a sensor and is controlled by the controller 300 to automatically deliver nanoparticles. For example, nanoparticle supply 250 may have a sensor 68 which actuate based on a fluid level in the containment 190, and can open release valve 302 when a fluid level, for example D1+D2, is reached. Other passive systems, such as a seal dissolvable by boiling coolant in the containment, could be used with the nanoparticle supplies 220, 230, 240, 250.

If the accident is a large pipe break, its late phases the level of boiling water in the containment 190 rises. The present invention thus advantageously provides that nanoparticles, which can enhance heat removal by the coolant, can be fed independently of the ECCS of both PWR's and BWR's. In the prior art, injection of the nanoparticles is driven by gravity and overpressure provided by the accumulators of the ECCS.

Even in small break accidents, the nanoparticles in supplies 240, 250 can be activated either passively or actively, even if the coolant level does not reach the supplies 240, 250. Nanofluid could simply drain into the containment 190. The nanoparticles, in this example in nanofluid form, advantageously thus can be fed directly to water in the containment 190.

Likewise, nanoparticle supplies 220, 230 can be activated passively or actively at appropriate times, for example when a containment coolant level reaches the lower part of the outside wall of the reactor vessel 10. These nanoparticle supplies 220, 230 advantageously can be self-contained, i.e. the entire supply located on or around at the outside wall of the reactor vessel 10. In the prior art, injection lines can terminate in the reactor cavity, but these injection lines may be subject to breaks or other failure, and having the nanoparticle supply self-contained in the immediate vicinity of the outside wall of the reactor vessel can help ensure delivery of the nanoparticles.

Nanoparticle-containing paint 202 may be located on walls of the reactor vessel 210 or walls of the containment or elsewhere inside the containment. Paint 202 is dissolvable in heated water or other fluid found during a LOCA accident in the containment, and in severe stages, where for example water may boil against the reactor vessel wall, paint 202 thus dissolves into the containment coolant, enhancing its heat removal properties.

Rather than nanofluids, nanoparticle supplies 220, 230, 240, 250 can provide solid nanopowder to be injected with the help of an inert gas flow provided from a flask with the gas pressure.

The nanoparticles are of sub-micron size, preferably in the 10-300 nanometer size. The nanoparticles preferably are non-abrasive, non-reactive and stable under severe accident conditions in view of radiation field, temperature and pressure considerations. The nanomaterials may include, but are not limited to, ZrO₂, C(diamond), Al₂O₃, SiO₂, Fe₃O₄, Cu, and CuO. When located in the paint, for example a water-soluble latex paint, the concentration can be determined as function of the desired paint properties.

The delivery of the nanoparticles can be designed to maintain a concentration in the containment water of less than 0.002 percent per volume, for example at 0.001 percent. For example, the nanoparticles can be delivered as a function of the calculated volume of water residing in the containment during accident or function of the RCS volume. A settling rate of the nanoparticles and dissolution rate of nanoparticle paint may be taken into account to time additional delivery of nanoparticles. These are just examples, and the exact amounts of nanoparticles released can be made dependent on nanoparticle type, reactor design, settling properties of the nanoparticles, and/or the type and severity of accident itself (for example if the LOCA or MSLB is a minor or major event). Nanoparticle supplies found elsewhere for example in the Emergency Core Cooling System and introduced there through other devices and methods can also be taken into account.

1. A nuclear power plant comprising:
a reactor;
a reactor coolant system having a coolant;
a containment, the reactor being located in the containment;
an emergency core cooling system for the reactor; and
a nanoparticle supply independent of the emergency core cooling system and capable of delivering nanoparticles to the coolant located in the containment after an accident.

2. The nuclear power plant as recited in claim 1 wherein the reactor includes a reactor vessel and insulation, and wherein the nanoparticle supply is located between the insulation and the reactor vessel.

3. The nuclear power plant as recited in claim 1 wherein the nanoparticle supply includes nanoparticle-containing paint in the containment.

4. The nuclear power plant as recited in claim 3 wherein the paint is located on a wall of the reactor in the containment.

5. The nuclear power plant as recited in claim 1 wherein the nanoparticle supply is located on a floor of the containment.

6. The nuclear power plant as recited in claim 5 wherein the nanoparticle supply is located a known distance above a lowest floor of the containment.

7. The nuclear power plant as recited in claim 5 wherein the nanoparticle supply is actuatable as a function of a coolant level found in the containment.

8. The nuclear power plant as recited in claim 1 wherein the nanoparticle supply is passively activatable.

9. The nuclear power plant as recited in claim 1 wherein the nanoparticle supply is activatable by an operator.

10. The nuclear power plant as recited in claim 1 wherein the nanoparticle supply is activatable via a motor-driven valve.

11. The nuclear power plant as recited in claim 1 wherein the nanoparticle supply provides a concentrated nanoparticle fluid.

12. The nuclear power plant as recited in claim 1 wherein the nanoparticle supply is pressurized.

13. A nuclear power plant comprising:
a reactor;
a containment, the reactor being located in the containment; and
a nanoparticle supply located in the containment and capable of providing nanoparticles directly to fluid in the containment.

14. A nuclear power plant comprising:
a reactor;
a containment, the reactor being located in the containment; and
a self-contained nanoparticle supply located in or on the reactor.

15. The nuclear power plant as recited in claim 14 wherein the reactor includes a reactor vessel having an exterior wall and insulation, the nanoparticle supply being located between the reactor vessel and insulation or on the exterior wall of the reactor vessel.

16. A nuclear power plant comprising:
a reactor;
a containment, the reactor being located in the containment; and
a nanoparticle supply located in the containment and actuatable as a function of a coolant level in the containment.

17. A nuclear power plant comprising:
a reactor;
a containment, the reactor being located in the containment; and
a nanoparticle-containing paint located in the containment, the nanoparticle-containing paint dissolvable by the coolant.

18. The nuclear power plant as recited in claim 16 wherein the nanoparticle-containing paint is located on an outside wall of the reactor vessel.

19. A method for improving accident heat removal capacity in a nuclear power plant comprising:
providing nanoparticles capable of being released directly into containment coolant found during an accident in a containment.

20. A method for improving accident heat removal capacity in a nuclear power plant comprising:
providing nanoparticles capable of being released independently of an emergency core cooling system.

21. A method for improving accident heat removal capacity in a nuclear power plant comprising:
painting sections of a containment with a coolant-dissolvable nanoparticle-containing paint.
